(19) United States
(12) Patent Application Publication
(10) Pub. No.: US 2026/0303280 A1
(43) Pub. Date: Oct. 1, 2026

(54) ESTIMATING A QUANTITY OF ACTIVE USERS FOR COLLISION CONTROL IN AN UPLINK RESOURCE POOL

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Thomas Joseph RICHARDSON, South Orange, NJ (US); Jing JIANG, San Diego, CA (US); Ori SHENTAL, Marlboro, NJ (US)

(21) Appl. No.: 19/089,879

(22) Filed: Mar. 25, 2025

(51) Int. Cl. H04L 5/00; H04W 28/04; H04W 52/14; H04W 72/1268

(52) U.S. Cl. CPC H04L 5/0044; H04W 28/04; H04W 52/146; H04W 72/1268

(57) ABSTRACT

This disclosure provides methods, components, devices and systems for estimating a quantity of active users for collision control in an uplink resource pool. For example, a user equipment (UE) may receive a message that allocates one or more resources for a common power signal associated with a set of UEs including at least the UE. The UE may transmit the common power signal via at least one resource of the one or more resources allocated in the message. A network entity may estimate a quantity of UEs in the set of UEs based on a power of the common power signal(s) from the set of UEs, and the network entity may transmit control signaling indicating either a resource pool for autonomous transmission of uplink data by the set of UEs or a configured grant procedure for subsequent transmissions by the set of UEs based on the estimated quantity of UEs.

### TECHNICAL FIELD

This disclosure relates generally to wireless communication, and more specifically to systems, devices, methods, and techniques associated with estimating a quantity of active users for collision control in an uplink resource pool.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a user equipment (UE) is described. The method may include receiving a message that allocates one or more resources for a common power signal associated with a set of UEs including at least the UE, transmitting the common power signal via at least one resource of the one or more resources based on the message, and receiving control signaling that indicates one of a resource pool for autonomous transmission of uplink data by the set of UEs or a configured grant (CG) procedure for subsequent transmissions of the uplink data by the set of UEs based on the common power signal.

A UE for wireless communication is described. The UE may include a processing system that includes processor circuitry and memory circuitry that stores code. The processing system may be configured to cause the UE to receive a message that allocates one or more resources for a common power signal associated with a set of UEs including at least the UE, transmit the common power signal via at least one resource of the one or more resources based on the message, and receive control signaling that indicates one of a resource pool for autonomous transmission of uplink data by the set of UEs or a CG procedure for subsequent transmissions of the uplink data by the set of UEs based on the common power signal.

Another UE for wireless communication is described. The UE may include means for receiving a message that allocates one or more resources for a common power signal associated with a set of UEs including at least the UE, means for transmitting the common power signal via at least one resource of the one or more resources based on the message, and means for receiving control signaling that indicates one of a resource pool for autonomous transmission of uplink data by the set of UEs or a CG procedure for subsequent transmissions of the uplink data by the set of UEs based on the common power signal.

A non-transitory computer-readable medium storing code for wireless communication is described. The code may include instructions executable by one or more processors to receive a message that allocates one or more resources for a common power signal associated with a set of UEs including at least the UE, transmit the common power signal via at least one resource of the one or more resources based on the message, and receive control signaling that indicates one of a resource pool for autonomous transmission of uplink data by the set of UEs or a CG procedure for subsequent transmissions of the uplink data by the set of UEs based on the common power signal.

In some examples of the method, UEs, and non-transitory computer-readable medium described herein, transmitting the common power signal may include operations, features, means, or instructions for transmitting the common power signal using a sequence, where the message indicates the sequence associated with the common power signal.

In some examples of the method, UEs, and non-transitory computer-readable medium described herein, transmitting the common power signal may include operations, features, means, or instructions for transmitting, in accordance with an open loop power control (OLPC) mode of the UE, the common power signal, where the control signaling may be further based on enablement of the OLPC mode at each UE of the set of UEs associated with the common power signal.

Some examples of the method, UEs, and non-transitory computer-readable medium described herein may further include operations, features, means, or instructions for determining whether the UE may have data for transmission via the resource pool, where transmitting the common power signal via the at least one resource may be based on determining that the UE does may have data for transmission via the resource pool.

In some examples of the method, UEs, and non-transitory computer-readable medium described herein, autonomously transmitting the uplink data via a second resource randomly selected from the resource pool indicated via the control signaling, where the control signaling indicates the resource pool for the autonomous transmission of the uplink data by the set of UEs based on an estimated quantity of UEs in the set of UEs being less than a threshold, and where the estimated quantity of UEs may be based on the common power signal.

Some examples of the method, UEs, and non-transitory computer-readable medium described herein may further include operations, features, means, or instructions for receiving, in accordance with the CG procedure, a CG that indicates one or more second resources, where the control signaling indicates the CG procedure based on an estimated quantity of UEs in the set of UEs exceeding a threshold, and where the estimated quantity of UEs may be based on the common power signal and transmitting the uplink data via the one or more second resources indicated via the CG.

### BRIEF DESCRIPTION OF THE DRAWINGS

FIG. 1 shows an example of a wireless communication system.

FIG. 2 shows an example of a signaling configuration that supports estimating a quantity of active users for collision control in an uplink resource pool.

FIG. 3 shows an example of a process flow that supports estimating a quantity of active users for collision control in an uplink resource pool.

FIG. 4 shows a block diagram of a processing system that supports estimating a quantity of active users for collision control in an uplink resource pool.

FIG. 5 shows a diagram of a system including a device that supports estimating a quantity of active users for collision control in an uplink resource pool.

FIGS. 6 through 9 show flowcharts illustrating methods that support estimating a quantity of active users for collision control in an uplink resource pool.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may configure a resource pool via which a set of user equipments (UEs) may transmit uplink data (e.g., uplink small packet transmissions) without explicit uplink grants (e.g., grants specifically allocating resources for transmission of the uplink data). In such wireless communication systems, a UE of the set of UEs may randomly select resources from the resource pool for an uplink transmission. The random selection of resources by each UE of the set of UEs may, in some examples, lead to collisions between uplink transmissions to the network entity, which may reduce uplink performance. The network entity may reduce a probability of collisions by allocating an appropriate quantity of resources for the resource pool. Thus, accounting for a quantity of UEs with uplink data to be transmitted via the resource pool when configuring the resource pool may be beneficial to reduce collisions and improve system throughput.

Aspects of the subject matter described in this disclosure relate to allowing a network entity to estimate a quantity of UEs expected to transmit uplink data via the resource pool in order to improve configuration of the resource pool (e.g., allocate an appropriate quantity of resources for the quantity of UEs) and reduce a probability of collisions. For example, the network entity may transmit a message that triggers transmission of a common power signal by a set of UEs that are within coverage of the network entity. The message may indicate a sequence to be transmitted, time and frequency resources via which to transmit the sequence, or both. A quantity of UEs may each receive the message (e.g., a broadcast or groupcast message), and each UE may determine whether to transmit the common power signal based on whether that UE has uplink data for transmission via the resource pool. The set of UEs may transmit the common power signal in accordance with the configuration, and the network entity may estimate a quantity of UEs expected to transmit uplink data via the resource pool based on a received power of the common power signal. The network entity may determine a quantity of resources for the resource pool based on the estimated quantity of UEs and may transmit a configuration for the resource pool to the set of UEs. Additionally, or alternatively, the network entity may transmit an indication to the set of UEs to follow a configured grant (CG) procedure (e.g., if the network estimates a high quantity of UEs).

Particular aspects of the subject matter described in this disclosure can be implemented to realize one or more of the following potential advantages. In some examples, by allowing the network entity to estimate the quantity of UEs expected to transmit uplink data via the resource pool and configure the resource pool accordingly, the described techniques can be used to reduce collisions, improve uplink performance, and improve system throughput. By reducing the likelihood of collisions, the described techniques may reduce processing and consumption of communication resources associated with retransmissions (e.g., in the event of collisions).

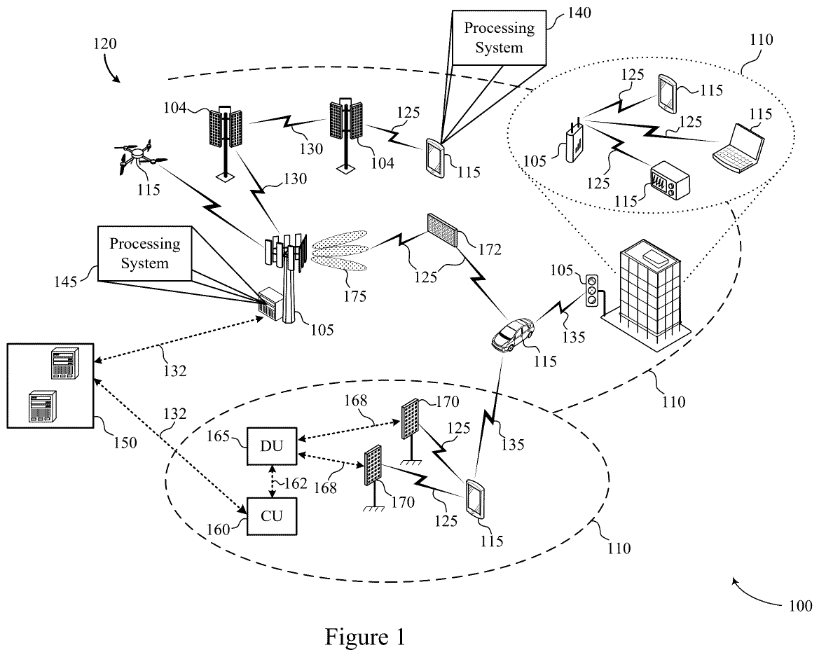

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for estimating a quantity of active users for collision control in an uplink resource pool. For example, a UE 115 may include a processing system 140, and a network entity 105 may include a processing system 145, each of which may be configured to cause the respective device to perform (such as being configured as means for performing) one or more of the described operations. In some examples, the wireless communication system 100 may support a resource pool via which a set of UEs 115 may transmit uplink data without explicit uplink grants. A UE 115 of the set of UEs 115 may receive (e.g., from a network entity 105) a message allocating one or more resources and indicating a sequence for a common power signal to be transmitted by the set of UEs 115. The UE 115 may transmit the common power signal via at least one resource of the one or more resources, and other UEs 115 of the set of UEs 115 may also transmit the common power signal using the same sequence (e.g., indicated in the message) and the at least one resource. The network entity 105 may estimate a quantity of UEs 115 expected to transmit on the resource pool based on a received power of the common power signal. Based on the estimated quantity of UEs 115, the network entity 105 may configure the uplink resource pool with an appropriate quantity of resources and indicate the uplink resource pool to the set of UEs 115 via control signaling, or, if the estimated quantity of UEs 115 is above a threshold, the network entity 105 may determine to follow a CG procedure and transmit a CG to the UE 115 allocating resources (e.g., in a UE-specific manner) for uplink transmissions.

By configuring a processing system 140, a processing system 145, or a combination thereof in accordance with the described techniques, the communication system 100 (such as the RAN 120) may support improved system throughput, improved uplink performance, reduced collisions, and improved coordination between devices.

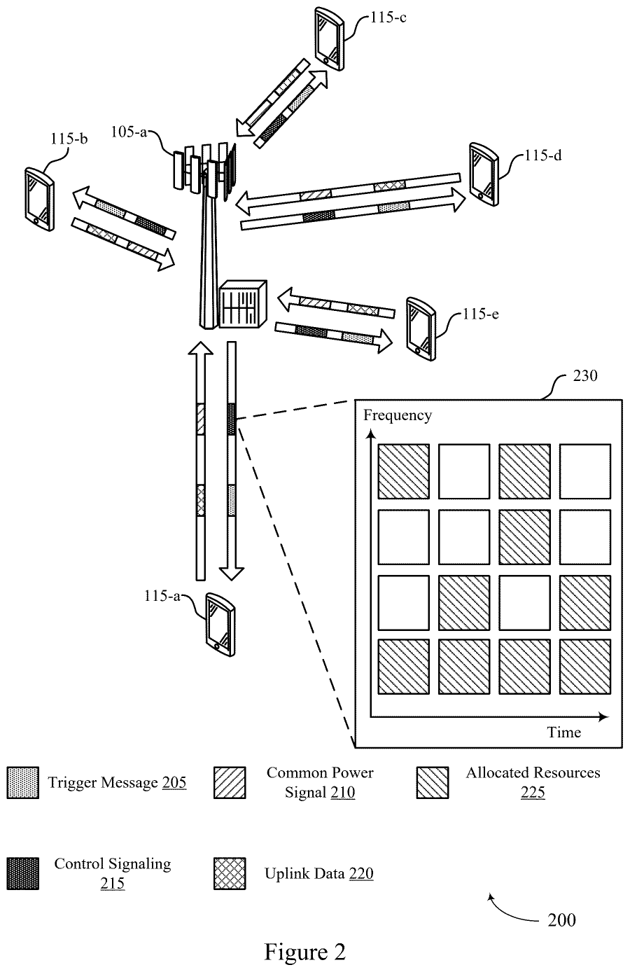

FIG. 2 shows an example of a signaling configuration 200 that supports estimating a quantity of active users for collision control in an uplink resource pool. In some examples, the signaling configuration 200 may implement, or be implemented by, aspects of the wireless communication system 100. For example, the signaling configuration 200 may include a network entity 105-a, which may be an example of a network entity 105 as described with reference to FIG. 1. Similarly, the signaling configuration 200 may include a UE 115-a, a UE 115-b, a UE 115-c, a UE 115-d, and a UE 115-e, which may be examples of UEs 115 as described with reference to FIG. 1.

In some examples of the signaling configuration 200, the network entity 105-a may configure (e.g., via control signaling 215) a resource pool 230 (e.g., a connectionless uplink resource pool) that a set of UEs 115 may use for uplink small packet transmission without explicit uplink grants. The network entity 105-a may allocate resources 225 (e.g., time and frequency resources) to the resource pool 230 based on traffic demands and a processing capability of the network entity 105-a, and the resource pool 230 may support a range of payload sizes (e.g., different payload sizes may be associated with different applications) and modulation and coding schemes (MCSs) (e.g., UEs 115 may be different distances from the network entity 105-a). The set of UEs 115 may autonomously select resources from the allocated resources 225 for transmission of uplink data 220, and the network entity 105-a may receive uplink data 220 from the set of UEs 115 using blind decoding.

That is, the UE 115-a, the UE 115-b, the UE 115-c, the UE 115-d, and the UE 115-e may each randomly select resources (e.g., time and frequency resources) from among the allocated resources 225 and transmit uplink data 220 to the network entity 105-a via the selected resources. The random selection of resources and contention-based transmission via the resource pool 230 may result in a probability of collisions, which may reduce uplink performance. For example, the UE 115-d may select a first range of time and frequency resources, and the UE 115-e may select a second range of time and frequency resources that may overlap with first range of time and frequency resources in time, frequency, or both, leading to a collision at the network entity 105-a between uplink transmissions from the UE 115-d and uplink transmissions from the UE 115-e. In some cases, the signaling configuration 200 may support a reception acknowledgment and retransmission mechanism to ensure reliable delivery of uplink packets via the resource pool 230. In some examples, the network entity 105-a may be associated with a relatively large cell (e.g., a large quantity of UEs 115 may transmit uplink data 220 via the resource pool 230), and the set of UEs 115 may acquire timing information before transmitting uplink data 220 via the resource pool 230. However, the probability of collisions and system throughput may be further improved by allocating an appropriate quantity of resources 225 for the resource pool 230 (e.g., based on the quantity of UEs 115 with uplink data 220 for transmission via the resource pool 230).

Accordingly, techniques described herein may allow the network entity 105-a to estimate a quantity of UEs 115 with uplink data 220 for transmission via the resource pool 230 and allocate resources 225 for the resource pool 230 accordingly to reduce the probability of collisions. Such techniques may be useful in cases (e.g., both eMBB and IoT cases) in which a relatively large quantity of UEs 115 are camped on a carrier. For example, UEs 115 in either connected mode or idle mode may be connected to a cell associated with the network entity 105-a, and the UEs 115 may be associated with relatively low duty cycle traffic and have relatively small packets for uplink transmission. In such cases, if the network entity 105-a configures the resource pool 230 for uplink small packet transmission with adequate resources 225 based on the quantity of UEs 115 with uplink data 220 for transmission via the resource pool 230, the resources within the resource pool 230 may be allocated to accommodate the UE transmissions, which may allow the UEs 115 to transmit the uplink data 220 with reduced overhead. The uplink data may include, for example, physical random access channel (PRACH) overhead, scheduling requests (SR), buffer status reports (BSR), uplink grants, CSI-RS, or any combination thereof.

In some examples, the network entity 105-a may transmit a trigger message 205 to trigger transmission of a common power signal 210 by UEs 115 with uplink data 220 for transmission via the resource pool 230. The trigger message 205 may include time and frequency resources for transmission of the common power signal 210, a sequence to be transmitted, or a combination thereof. The sequence to be transmitted may, in some examples, be a Zadoff-Chu (ZC) sequence, a maximum-length sequence (m-sequence), or another sequence with good peak-to-average power ratio (PAPR) properties for power efficiency. The length of the sequence to be transmitted may be relatively short (e.g., compared to PRACH) because the received power (e.g., at the network entity 105-a) may be the relevant metric associated with the common power signal 210. In some cases, the network entity 105-a may broadcast the trigger message 205 to UEs 115 within coverage of the network entity 105-a, and each UE 115 may decode the downlink signaling and determine if that UE 115 has uplink data 220 for transmission via the resource pool 230. In some aspects, a group of UEs 115 may monitor a group-common PDCCH identified by a group-common radio network temporary identifier (RNTI) or another identifier, or any combination thereof, for the trigger message 205.

A UE 115 (e.g., the UE 115-a, the UE 115-b, the UE 115-c, the UE 115-d, the UE 115-e, or any combination thereof) may determine that the UE 115 has uplink data 220 for transmission via the resource pool 230 and may accordingly transmit the common power signal 210 using a sequence and resources indicated in the trigger message 205. That is, a set of UEs 115 with uplink data 220 for transmission via the resource pool 230 may transmit the common power signal 210 (e.g., a same sequence) for reception at the network entity 105-a. The set of UEs 115 may implement open loop power control (OLPC) for transmitting the sequence, in some examples. That is, each UE 115 of the set of UEs 115 may adjust a transmission power associated with that UE 115 based on internal measurements without feedback from the network entity 105-a, such that the network entity 105-a may receive transmissions by each UE 115 of the set of UEs 115 with a same (e.g., at least within a threshold) received power. Additionally, or alternatively, a given UE 115 may determine that the given UE 115 has no uplink data for transmission via the resource pool 230, and the given UE 115 may accordingly refrain from transmitting the common power signal 210.

The network entity 105-a may receive the common power signal 210 from the set of UEs 115 and measure the received power to estimate a quantity of UEs 115 with uplink data 220 for transmission via the resource pool 230. The network entity 105-a may correlate the quantity of UEs 115 with uplink data 220 for transmission via the resource pool 230 to the total received power of the common power signal 210 based on assuming that the set of UEs 115 implemented OLPC. That is, an OLPC mode may allow the network entity 105-a to receive each transmission of the common power signal (e.g., by each UE 115 of the set of UEs 115) with a same received power, such that the total received power of the common power signal (e.g., a sum of the received powers of each transmission of the common power signal by each UE 115) may be directly correlated with a quantity of UEs 115 that transmitted the common power signal. The network entity 105-a estimating the quantity of UEs 115 with uplink data 220 for transmission via the resource pool 230 based on the received power of the common power signal 210 in accordance with the techniques described herein may reduce a quantity of resources associated with estimating the quantity of UEs 115 (e.g., the network entity 105-a configures and receives a single common power signal 210) compared to separate signaling between the network entity 105-a and each UE 115 (e.g., to identify each UE 115 with uplink data 220 for transmission via the resource pool 230).

In some implementations, the network entity 105-a may allocate (e.g., in the trigger message 205) separate sets of resources (e.g., time division multiplexing (TDM) resources, frequency division multiplexing (FDM) resources, code division multiplexing (CDM) resources) for transmission of multiple common power signals 210, where each set of allocated resources for transmission of the common power signals 210 is associated with (e.g., assigned, mapped to, allocated for) a target uplink power of a corresponding UE 115 (e.g., a target power with which the common power signal 210 may be transmitted by the UE 115 and/or received at the network entity 105-a). That is, the trigger message 205 may map resources and a sequence for the common power signal 210 to respective ranges of a plurality of candidate ranges of uplink powers (e.g., of the common power signal 210). For example, the network entity 105-a may allocate orthogonal sequences (e.g., for the common power signal 210) for a given range of uplink powers in cases of CDM, or the network entity 105-a may allocate a same sequence for a given range of uplink powers in cases of TDM, FDM, or both.

The network entity 105-a configuring separate resources for ranges of uplink powers may be useful for UEs 115 that are unable to transmit the common power signal 210 with the target uplink power (e.g., coverage limited UEs, low power UEs). For example, the network entity 105-a may still be able to estimate a quantity of UEs 115 by measuring a combined power of each common power signal 210 received via each respective set of resources. That is, a set of UEs 115 with target uplink powers corresponding to a given candidate range of uplink powers may transmit a common power signal 210 using one or more resources, a sequence, or both associated with the given candidate range. The network entity 105-a may accordingly receive transmissions of the common power signal from the set of UEs 115 with a same received power and may correlate a quantity of UEs 115 associated with the given candidate range to a total received power of the common power signal (e.g., a sum of received powers of each transmission of the common power signal). The network entity 105-a may in this manner estimate a quantity of UEs 115 associated with the given candidate range and may estimate a quantity of UEs 115 for each of the candidate ranges in the same manner in order to obtain an estimate of a total quantity of UEs 115 with uplink data 220 for transmission via the resource pool 230.

In such implementations, the UEs 115 may select a TDM resource, an FDM resource, a CDM resource, or any combination thereof based on a measured downlink reference signal received power (RSRP) and a transmit power. For example, the UE 115-a may estimate an uplink power of a subsequent transmission of the common power signal 210 by the UE 115-a based on a transmit power associated with the UE 115-a and a measured downlink RSRP at the UE 115-a, and the UE 115-a may select resources for transmission of the common power signal 210 that map to the estimated uplink power. In some cases, the network entity 105-a may apply successive-interference cancellation (SIC) when measuring the common power signal 210 from UEs with a lower uplink power. That is, the network entity 105-a may apply SIC when measuring a common power signal 210 transmitted via time and frequency resources, using a sequence, or both that are mapped to a range of low uplink powers.

Similarly, the network entity 105-a may allocate (e.g., in the trigger message 205) separate sets of resources (e.g., TDM resources, FDM resources, CDM resources) for transmission of multiple common power signals 210, where each set of allocated resources for transmission of the common power signals 210 is associated with (e.g., assigned, mapped to, allocated for) a size of an uplink payload for transmission via the resource pool 230 by a corresponding UE 115. That is, the trigger message 205 may map resources and a sequence for the common power signal 210 to respective ranges of a plurality of candidate ranges of uplink payload sizes. Each UE 115 may select resources for transmission of the common power signal 210 based on a size of an uplink payload for transmission by that UE 115 via the resource pool 230. For example, the UE 115-b may have an uplink payload of a given size to transmit via the resource pool 230, and the UE 115-b may select a sequence and a resource for transmission of the common power signal 210 that are mapped to the given size in the trigger message 205.

Based on the mapping in the trigger message 205, a set of UEs 115 associated with uplink payloads corresponding to a given candidate range of uplink payload sizes may transmit a common power signal 210 using one or more resources, a sequence, or both associated with the given candidate range. The network entity 105-a may accordingly receive transmissions of the common power signal from the set of UEs 115 with a same received power and may correlate a quantity of UEs 115 associated with the given candidate range to a total received power of the common power signal (e.g., a sum of received powers of each transmission of the common power signal). The network entity 105-a may in this manner estimate a quantity of UEs 115 associated with the given candidate range of uplink payload sizes and may estimate a quantity of UEs 115 for each of the candidate ranges in the same manner in order to obtain an estimate of a total quantity of UEs 115 with uplink data 220 for transmission via the resource pool 230. The network entity 105-a may also obtain an estimate of a volume of uplink data 220 for transmission via the resource pool 230 based on how many UEs 115 are associated with each candidate range of uplink payload sizes.

Additionally, or alternatively, the network entity 105-a may allocate (e.g., in the trigger message 205) separate sets of resources (e.g., TDM resources, FDM resources, CDM resources) for transmission of multiple common powers signal 210, where each set of allocated resources for transmission of the common power signals 210 is associated with (e.g., assigned, mapped to, allocated for) an MCS (e.g., an MCS according to which a corresponding UE 115 may transmit in the resource pool 230). That is, the trigger message 205 may map resources and a sequence for the common power signal 210 to respective ranges of a plurality of candidate ranges of MCSs. Each UE 115 may select resources for transmission of the common power signal 210 based on an MCS used by that UE 115 (e.g., for transmission via the resource pool 230). For example, the UE 115-c may expect to transmit via the resource pool 230 using a given MCS, and the UE 115-c may select a sequence and a resource for transmission of the common power signal 210 that are mapped to the given MCS in the trigger message 205.

Based on the mapping in the trigger message 205, a set of UEs 115 associated with MCSs corresponding to a given candidate range of MCSs may transmit a common power signal 210 using one or more resources, a sequence, or both associated with the given candidate range. The network entity 105-a may accordingly receive transmissions of the common power signal from the set of UEs 115 with a same received power and may correlate a quantity of UEs 115 associated with the given candidate range to a total received power of the common power signal (e.g., a sum of received powers of each transmission of the common power signal). The network entity 105-a may in this manner estimate a quantity of UEs 115 associated with the given candidate range and may estimate a quantity of UEs 115 for each of the candidate ranges in the same manner in order to obtain an estimate of a total quantity of UEs 115 with uplink data 220 for transmission via the resource pool 230.

In some cases, the network entity 105-a may allocate resources 225 (e.g., via control signaling 215) to the resource pool 230 for uplink small packet transmission based on the measured received power of the common power signal 210. For example, the network entity 105-a may estimate a quantity of UEs 115 with uplink data 220 for transmission via the resource pool 230 based on the measured received power of the common power signal 210 (e.g., a total sum of received power), and may allocate resources 225 accordingly. The network entity 105-a may allocate a greater quantity of resources 225 to the resource pool 230 if the network entity 105-a estimates a relatively large quantity of UEs 115 with uplink data 220 for transmission via the resource pool 230, and the network entity 105-a may allocate a smaller quantity of resources 225 to the resource pool 230 if the network entity 105-a estimates a relatively smaller quantity of UEs 115 with uplink data 220 for transmission via the resource pool 230 (e.g., the network entity 105-a may allocate resources 225 proportionally to the estimated quantity of UEs 115). In some aspects, the network entity 105-a may dynamically change resources 225 for the resource pool 230 through group common (GC) PDCCH based on the estimated quantity of UEs 115. Additionally, or alternatively, the network entity 105-a may implement a CG procedure to reduce the probability of collisions if the network entity 105-a estimates a quantity of UEs 115 is above a threshold (e.g., the resource pool 230 may be unable to support transmissions by a quantity of UEs 115 that is above the threshold without a relatively large quantity of collisions).

The network entity 105-a may transmit control signaling 215 to the UEs 115 to either configure the resource pool 230 or to indicate that the UEs 115 should follow a CG procedure. In some implementations, individual resources 225 within the resource pool 230 may be mapped to a threshold MCS, a threshold transmit power, or both in the configuration of the resource pool 230 (e.g., indicated in the control signaling 215). That is, a UE 115 may be associated with an MCS and a transmit power, and the UE 115 may refrain from transmitting via a resource (e.g., of the resource pool 230) if the MCS associated with the UE 115 does not satisfy a threshold MCS associated with the resource or if the transmit power associated with the UE 115 does not satisfy a threshold transmit power.

In some examples, the UEs 115 may transmit uplink data 220 via the resource pool 230 based on receiving the control signaling 215 configuring the resource pool 230. That is, the control signaling 215 may allocate resources 225 for the resource pool 230, and the UEs 115 may randomly select resources from the resource pool 230 for transmission of uplink data 220. Configuration of the resource pool 230 based on an estimated quantity of UEs 115 with uplink data 220 for transmission via the resource pool 230 in accordance with the techniques described herein may reduce a probability of collisions associated with random selection of resources from the resource pool 230 by the UEs 115, and accordingly improve communication reliability and reduce consumption of communication resources associated with retransmissions (e.g., in the event of collisions). Additionally, or alternatively, the control signaling 215 may include an indication to follow a CG procedure, and the UEs 115 may transmit the uplink data 220 on resources allocated via the CG procedure.

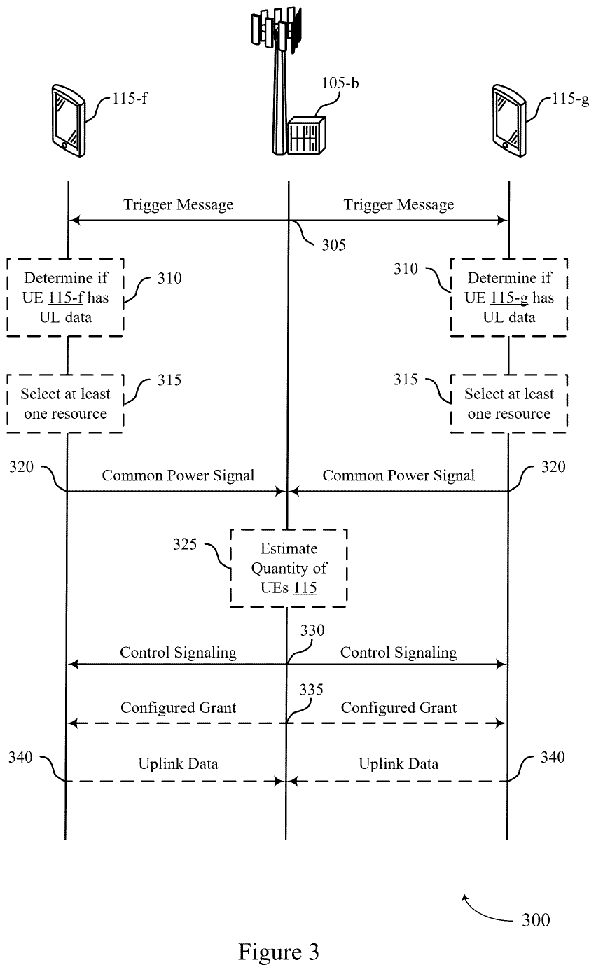

FIG. 3 shows an example of a process flow 300 that supports estimating a quantity of active users for collision control in an uplink resource pool. The process flow 300 may implement or be implemented to realize aspects of the wireless communication system 100 or the signaling configuration 200. For example, the process flow 300 may include a UE 115-f and a UE 115-g, which may be examples of the UE 115-a, the UE 115-b, the UE 115-c, the UE 115-d, the UE 115-e, or any combination thereof, as illustrated in FIG. 2, or other UEs 115, as illustrated in FIG. 1. Similarly, the process flow 300 may include a network entity 105-b, which may be an example of the network entity 105-a, as illustrated in FIG. 2, or other network entities 105, as illustrated in FIG. 1.

In the following description of the process flow 300, the operations between the UE 115-f, the network entity 105-b, and the UE 115-g may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the network entity 105-b may broadcast a trigger message, which may be received by at least the UE 115-f and the UE 115-g. The trigger message may trigger a set of UEs, which may include the UE 115-f and the UE 115-g, to transmit a common power signal (e.g., the set of UEs may transmit a same sequence via a same set of resources). In some cases, the trigger message may indicate one or more resources (e.g., time and frequency resources) for transmission of the common power signal, a sequence of the common power signal, or a combination thereof. In some cases, the sequence of the common power signal may be a ZC sequence, an m-sequence, or another sequence with good PAPR properties for power efficiency.

In some implementations, the trigger message may include mapping information that maps each resource of the one or more resources to a respective range of a plurality of candidate ranges of expected uplink powers of the common power signal. That is, the network entity 105-b may configure, in the trigger message, separate resources (e.g., TDM resources, FDM resources, CDM resources) for transmission of the common power signal based on a target uplink power of the common power signal. The mapping information may indicate a correspondence between a range of expected uplink powers and at least one resource of the one or more resources, a sequence of the common power signal, or both.

Additionally, or alternatively, the trigger message may include mapping information that maps each resource of the one or more resources to a respective range of a plurality of candidate ranges of uplink payload sizes, to a respective range of a plurality of candidate ranges of MCSs, or both. For example, the mapping information may indicate a correspondence between a range of quantities of uplink data for transmission by a UE 115 and at least one resource of the one or more resources, a sequence of the common power signal, or both. Likewise, the mapping information may indicate a correspondence between a range of MCSs that may be used by at UE 115 and at least one resource of the one or more resources, a sequence of the common power signal, or both.

At 310, the UE 115-f may decode the trigger message received at 305 and determine whether the UE 115-f has uplink data for transmission via a resource pool for autonomous uplink transmissions (e.g., a connectionless uplink resource pool). Likewise, at 310, the UE 115-g may decode the trigger message received at 305 and determine whether the UE 115-g has uplink data for transmission via the resource pool. If a given UE 115 (e.g., the UE 115-f, the UE 115-g) determines that the given UE 115 has uplink data for transmission via the resource pool, the given UE 115 may determine to transmit the common power signal. If a given UE 115 determines that the given UE 115 does not have uplink data for transmission via the resource pool, the given UE 115 may refrain from transmitting the common power signal.

At 315, the UE 115-f and the UE 115-g may, in some implementations, select at least one resource for transmission of the common power signal. For example, the UE 115-f and the UE 115-g may each select the at least one resource based on determining the UE 115-f and the UE 115-g have uplink data to transmit and based on mapping information indicated in the trigger message. In some cases, a UE 115 (e.g., the UE 115-f, the UE 115-g, or both) may determine an expected uplink power of the common power signal based on a downlink RSRP (e.g., measured on a RS transmitted by the network entity 105-b) and a transmit power associated with the UE 115. The UE 115 may accordingly select the at least one resource based on the mapping information that maps each resource of the one or more resources to a respective range of a plurality of candidate ranges of expected uplink powers of the common power signal, where the mapping information indicates that the determined expected uplink power corresponds to the selected at least one resource. Additionally, or alternatively, the UE 115 may select the at least one resource based on a quantity of uplink data for transmission by the UE 115 (e.g., an uplink payload) and the mapping information that maps each resource of the one or more resources to a respective range of a plurality of candidate ranges of uplink payload sizes, where the mapping information indicates that the quantity of uplink data for transmission by the UE 115 corresponds to the selected at least one resource. The UE 115 may, in some aspects, select the at least one resource based on an MCS associated with the UE 115 and the mapping information that maps each resource of the one or more resources to a respective range of a plurality of candidate ranges of MCSs, where the mapping information indicates that the MCS associated with the UE 115 corresponds to the selected at least one resource.

At 320, the UE 115-f and the UE 115-g may transmit the common power signal to the network entity 105-b via the selected resource(s). The network entity 105-b may also receive the common power signal from a quantity of other UEs 115. In some examples, the UE 115-f and the UE 115-g may transmit the common power signal via the at least one resource selected at 315, using a sequence indicated in the trigger message at 305, or both.

The UE 115-f, the UE 115-g, and the quantity of other UEs 115 may transmit the common power signal, which may allow the UE 115-f, the UE 115-g, and the quantity of other UEs 115 to transmit a same sequence via a same set of resources (e.g., which may be indicated in the trigger message at 305) for reception at the network entity 105-b. If the UEs 115-f and 115-g use an OLPC mode for the transmission of the common power signal, the network entity 105-b may receive each transmission of the common power signal with a same received power, such that the total received power of the common power signal (e.g., a sum of the received powers of each transmission of the common power signal by each UE 115) may be directly correlated with a quantity of UEs 115 that transmitted the common power signal. Additionally, or alternatively, each UE 115 may transmit the common power signal via the at least one resource selected (e.g., at 315) based on the mapping information, such that the network entity 105-b may receive each transmission of a common power signal using resources, a sequence, or both that correspond to a candidate range (e.g., of expected uplink powers, uplink payload sizes, MCSs, or a combination thereof) with a same received power. The network entity 105-b may accordingly directly correlate the total received power of the common power signal for the candidate range to a quantity of UEs 115 that transmitted the common power signal for the candidate range in order to estimate a quantity of UEs 115 associated with the candidate range.

At 325, the network entity 105-b may, in some cases, estimate a quantity of UEs 115 with uplink data for transmission via the resource pool for autonomous uplink transmissions based on a received power of the common power signal. That is, the network entity 105-b may correlate the quantity of UEs 115 with uplink data for transmission via the resource pool to the received power of the common power signal based on an assumption that the UE 115-f, the UE 115-g, and the quantity of other UEs 115 implemented OLPC for transmission of the common power signal.

At 330, the network entity 105-b may transmit (e.g., to the UE 115-f and the UE 115-g) control signaling indicating one of the resource pool for autonomous uplink transmissions or a CG procedure for subsequent transmissions of uplink data based on estimating the quantity of UEs 115 at 325. That is, the network entity 105-b may determine if the estimated quantity of UEs 115 exceeds a threshold and accordingly may transmit control signaling indicating the CG procedure if the estimated quantity of UEs 115 exceeds the threshold. If the estimated quantity of UEs 115 is less than the threshold, the network entity 105-b may transmit control signaling indicating the resource pool for autonomous uplink transmissions.

For example, the network entity 105-b may, if the estimated quantity of UEs 115 is less than the threshold, allocate resources to the resource pool proportionally to the estimated quantity of UEs 115. In some aspects, individual resources allocated to the resource pool may be mapped to a threshold MCS, a threshold transmit power, or both. The network entity 105-b allocating resources to the resource pool based on the estimated quantity of UEs 115 may reduce a probability of collisions, thereby improving uplink performance and reliability of communications. The network entity 105-b allocating resources to the resource pool based on the estimated quantity of UEs 115 may also improve utilization of communication resources (e.g., the network entity 105-b may refrain from allocating more resources to the resource pool than may be used by the UEs 115).

If the estimated quantity of UEs 115 exceeds the threshold, the resource pool may be unable to support transmissions by the estimated quantity of UEs 115, and the network entity 105-b may accordingly indicate a CG procedure in the control signaling at 330. The network entity 105-b indicating a CG procedure based on the estimated quantity of UEs 115 when the estimated quantity of UEs 115 exceeds the threshold may reduce the probability of collisions in cases in which a relatively large quantity of UEs 115 have uplink data to transmit to the network entity 105-b (e.g., the resource pool may be unable to support transmissions by the relatively large quantity of UEs 115).

At 335, the network entity 105-b may, if the estimated quantity of UEs 115 exceeds the threshold, transmit a CG to the UE 115-f and the UE 115-g in accordance with the CG procedure. For example, the network entity 105-b may transmit a CG to the UE 115-f allocating one or more resources (e.g., in a UE-specific manner) to the UE 115-f for subsequent transmissions of uplink data.

At 340, the UE 115-f and the UE 115-g may, in some examples, transmit uplink data to the network entity 105-b. In some cases (e.g., if the control signaling indicates a resource pool for autonomous uplink transmissions), the UE 115-f and the UE 115-g may randomly select one or more resources from the resource pool for autonomous uplink transmissions and transmit the uplink data via the one or more randomly selected resources. In some examples (e.g., if the control signaling indicates a CG procedure), the UE 115 may transmit the uplink data via one or more resources allocated in a CG (e.g., the CG received at 335).

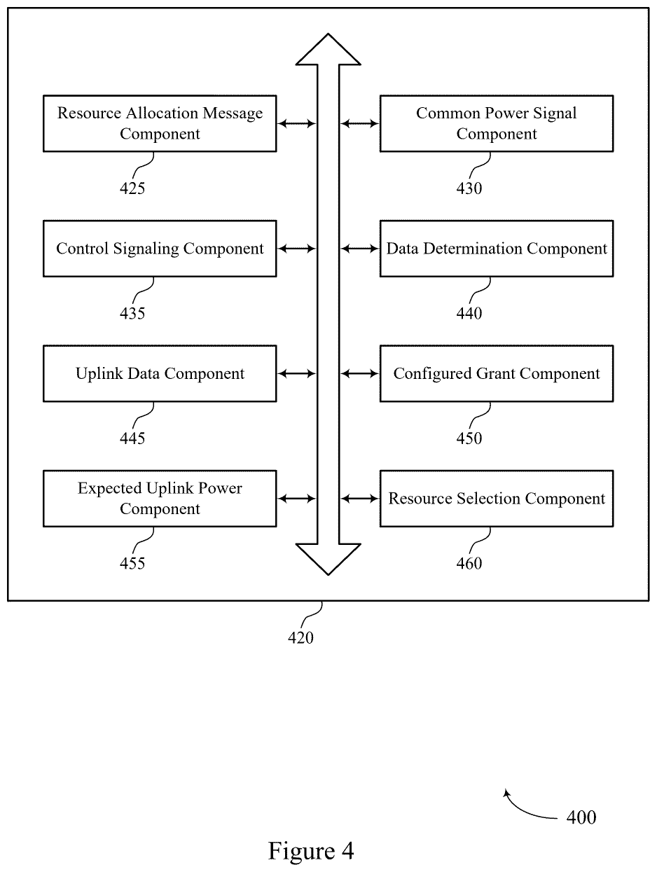

FIG. 4 shows an example of a processing system 420 that supports estimating a quantity of active users for collision control in an uplink resource pool. A processing system 420 may be an example of a processing system 140 (such as of a UE 115) and may include a resource allocation message component 425, a common power signal component 430, a control signaling component 435, a data determination component 440, an uplink data component 445, a CG component 450, an expected uplink power component 455, a resource selection component 460, or any combination thereof. A processing system 420, or various component thereof, may be an example of means for performing (such as a means for causing a UE 115 to perform) various techniques described herein.

The resource allocation message component 425 may be configured to cause the UE 115 to receive a message that allocates one or more resources for a common power signal associated with a set of UEs including at least the UE. The common power signal component 430 may be configured to cause the UE 115 to transmit the common power signal via at least one resource of the one or more resources based on the message. The control signaling component 435 may be configured to cause the UE 115 to receive control signaling that indicates one of a resource pool for autonomous transmission of uplink data by the set of UEs or a CG procedure for subsequent transmissions of the uplink data by the set of UEs based on the common power signal.

In some examples, to support transmitting the common power signal, the common power signal component 430 may be configured to cause the UE 115 to transmit the common power signal using a sequence, where the message indicates the sequence associated with the common power signal.

In some examples, the sequence is a ZC sequence, an m-sequence, or both.

In some examples, to support transmitting the common power signal, the common power signal component 430 may be configured to cause the UE 115 to transmit, in accordance with an OLPC mode of the UE, the common power signal, where the control signaling is further based on enablement of the OLPC mode at each UE of the set of UEs associated with the common power signal.

In some examples, the message further includes mapping information that maps each resource of the one or more resources to a respective range of a set of multiple candidate ranges of expected uplink powers. In some examples, transmission of the common power signal via the at least one resource is based on an expected uplink power associated with the UE and the mapping information.

In some examples, the expected uplink power component 455 may be configured to cause the UE 115 to determine the expected uplink power associated with the UE based on a measured downlink RSRP and a transmit power associated with the UE. In some examples, the resource selection component 460 may be configured to cause the UE 115 to select the at least one resource from among the one or more resources indicated via the message for transmission of the common power signal based on the mapping information indicating that the at least one resource is mapped to a first range, of the set of multiple candidate ranges, that includes the expected uplink power.

In some examples, the message further includes mapping information that maps each resource of the one or more resources to a respective range of a set of multiple candidate ranges of uplink payload sizes. In some examples, transmission of the common power signal via the at least one resource is based on an uplink payload size associated with the UE and the mapping information.

In some examples, the resource selection component 460 may be configured to cause the UE 115 to select the at least one resource from among the one or more resources indicated via the message for transmission of the common power signal based on the mapping information indicating that the at least one resource is mapped to a first range, of the set of multiple candidate ranges, that includes the uplink payload size.

In some examples, the message further includes mapping information that maps each resource of the one or more resources to a respective range of a set of multiple candidate ranges of MCSs. In some examples, transmission of the common power signal via the at least one resource is based on an MCS associated with the UE and the mapping information.

In some examples, the resource selection component 460 may be configured to cause the UE 115 to select the at least one resource from among the one or more resources indicated via the message for transmission of the common power signal based on the mapping information indicating that the at least one resource is mapped to a first range, of the set of multiple candidate ranges, that includes the MCS.

In some examples, the data determination component 440 may be configured to cause the UE 115 to determine whether the UE has data for transmission via the resource pool, where transmitting the common power signal via the at least one resource is based on determining that the UE does have data for transmission via the resource pool.

In some examples, the uplink data component 445 may be configured to cause the UE 115 to autonomously transmit the uplink data via a second resource randomly selected from the resource pool indicated via the control signaling, where the control signaling indicates the resource pool for the autonomous transmission of the uplink data by the set of UEs based on an estimated quantity of UEs in the set of UEs being less than a threshold, and where the estimated quantity of UEs is based on the common power signal.

In some examples, the CG component 450 may be configured to cause the UE 115 to receive, in accordance with the CG procedure, a CG that indicates one or more second resources, where the control signaling indicates the CG procedure based on an estimated quantity of UEs in the set of UEs exceeding a threshold, and where the estimated quantity of UEs is based on the common power signal. In some examples, the uplink data component 445 may be configured to cause the UE 115 to transmit the uplink data via the one or more second resources indicated via the CG.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for more efficient utilization of communication resources and reduced processing.

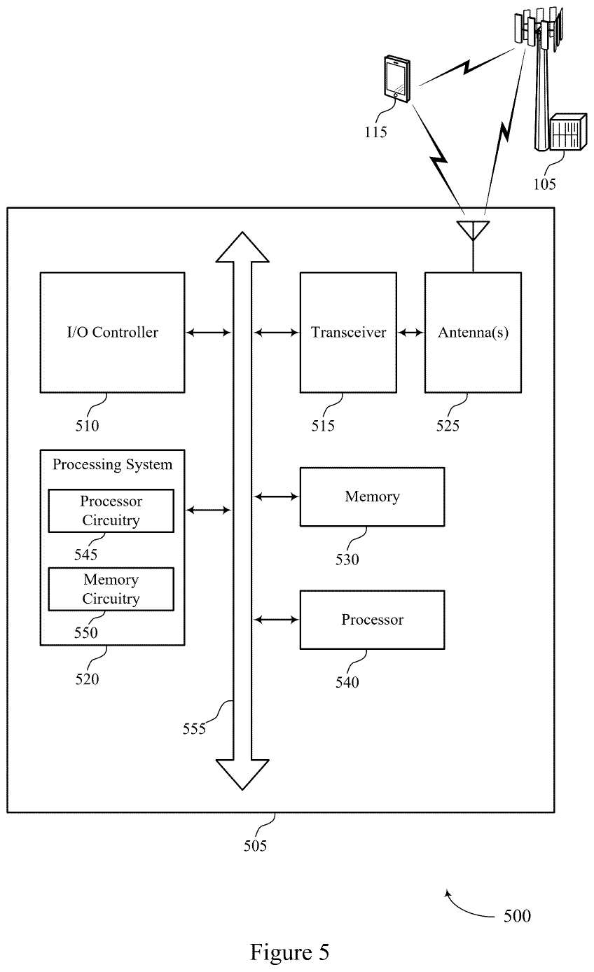

FIG. 5 shows an example of a system 500 including a device 505 that supports estimating a quantity of active users for collision control in an uplink resource pool. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support estimating a quantity of active users for collision control in an uplink resource pool. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, more efficient utilization of communication resources, and improved coordination between devices.

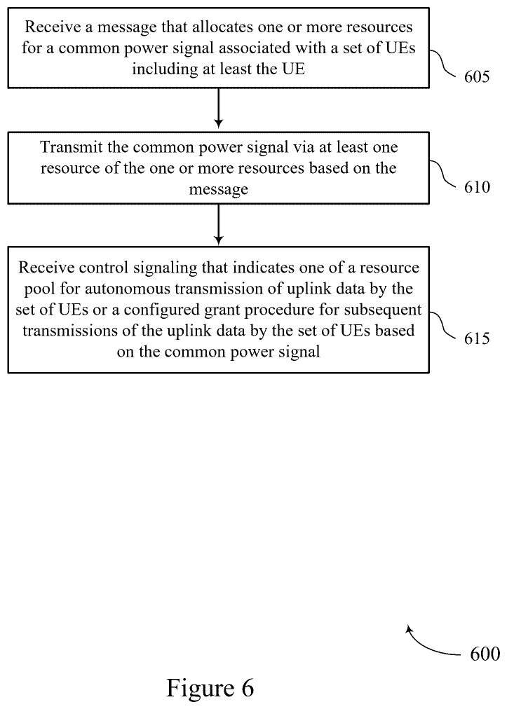

FIG. 6 shows an example of a method 600 that supports estimating a quantity of active users for collision control in an uplink resource pool. Operations of the method 600 may be performed by a UE or its components (such as using a processing system configured to cause the UE 115 to perform one or more of the operations) as described herein.

At 605, the method may include receiving a message that allocates one or more resources for a common power signal associated with a set of UEs including at least the UE. In some examples, aspects of the operations of 605 may be performed by a resource allocation message component 425.

At 610, the method may include transmitting the common power signal via at least one resource of the one or more resources based on the message. In some examples, aspects of the operations of 610 may be performed by a common power signal component 430.

At 615, the method may include receiving control signaling that indicates one of a resource pool for autonomous transmission of uplink data by the set of UEs or a CG procedure for subsequent transmissions of the uplink data by the set of UEs based on the common power signal. In some examples, aspects of the operations of 615 may be performed by a control signaling component 435.

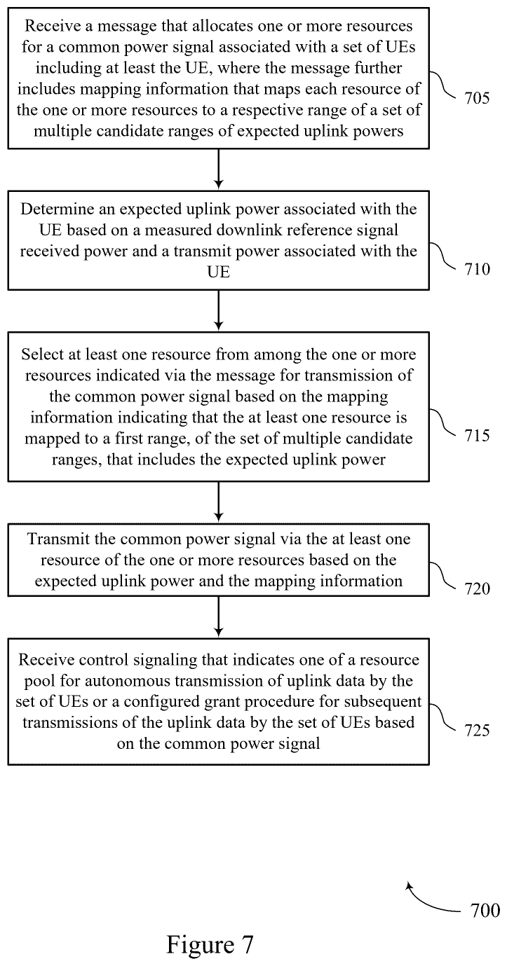

FIG. 7 shows an example of a method 700 that supports estimating a quantity of active users for collision control in an uplink resource pool. Operations of the method 700 may be performed by a UE or its components (such as using a processing system configured to cause the UE 115 to perform one or more of the operations) as described herein.

At 705, the method may include receiving a message that allocates one or more resources for a common power signal associated with a set of UEs including at least the UE, where the message further includes mapping information that maps each resource of the one or more resources to a respective range of a set of multiple candidate ranges of expected uplink powers. In some examples, aspects of the operations of 705 may be performed by a resource allocation message component 425.

At 710, the method may include determining an expected uplink power associated with the UE based on a measured downlink RSRP and a transmit power associated with the UE. In some examples, aspects of the operations of 710 may be performed by an expected uplink power component 455.

At 715, the method may include selecting at least one resource from among the one or more resources indicated via the message for transmission of the common power signal based on the mapping information indicating that the at least one resource is mapped to a first range, of the set of multiple candidate ranges, that includes the expected uplink power. In some examples, aspects of the operations of 715 may be performed by a resource selection component 460.

At 720, the method may include transmitting the common power signal via the at least one resource of the one or more resources based on the expected uplink power and the mapping information. In some examples, aspects of the operations of 720 may be performed by a common power signal component 430.

At 725, the method may include receiving control signaling that indicates one of a resource pool for autonomous transmission of uplink data by the set of UEs or a CG procedure for subsequent transmissions of the uplink data by the set of UEs based on the common power signal. In some examples, aspects of the operations of 725 may be performed by a control signaling component 435.

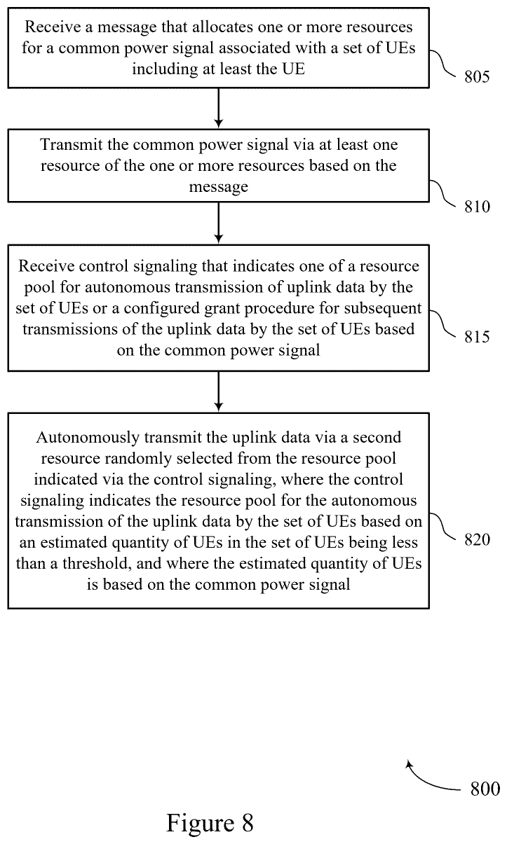

FIG. 8 shows an example of a method 800 that supports estimating a quantity of active users for collision control in an uplink resource pool. Operations of the method 800 may be performed by a UE or its components (such as using a processing system configured to cause the UE 115 to perform one or more of the operations) as described herein.

At 805, the method may include receiving a message that allocates one or more resources for a common power signal associated with a set of UEs including at least the UE. In some examples, aspects of the operations of 805 may be performed by a resource allocation message component 425.

At 810, the method may include transmitting the common power signal via at least one resource of the one or more resources based on the message. In some examples, aspects of the operations of 810 may be performed by a common power signal component 430.

At 815, the method may include receiving control signaling that indicates one of a resource pool for autonomous transmission of uplink data by the set of UEs or a CG procedure for subsequent transmissions of the uplink data by the set of UEs based on the common power signal. In some examples, aspects of the operations of 815 may be performed by a control signaling component 435.

At 820, the method may include autonomously transmitting the uplink data via a second resource randomly selected from the resource pool indicated via the control signaling, where the control signaling indicates the resource pool for the autonomous transmission of the uplink data by the set of UEs based on an estimated quantity of UEs in the set of UEs being less than a threshold, and where the estimated quantity of UEs is based on the common power signal. In some examples, aspects of the operations of 820 may be performed by an uplink data component 445.

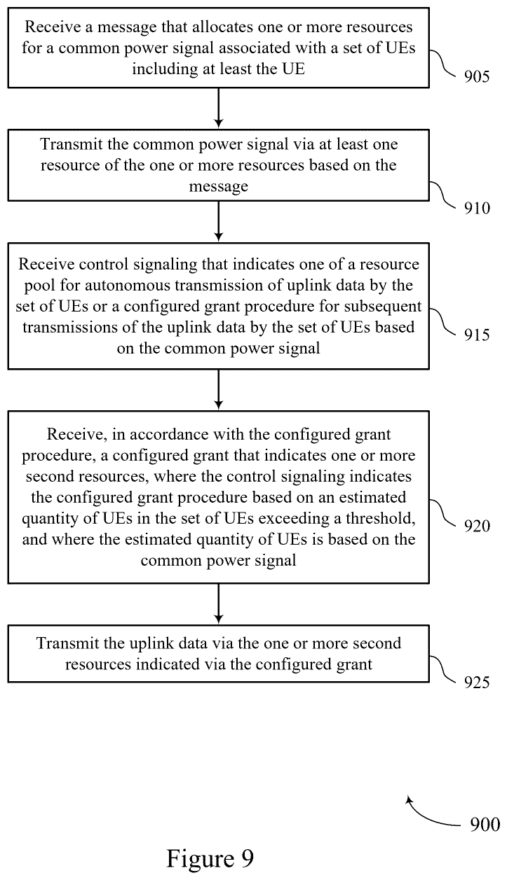

FIG. 9 shows an example of a method 900 that supports estimating a quantity of active users for collision control in an uplink resource pool. Operations of the method 900 may be performed by a UE or its components (such as using a processing system configured to cause the UE 115 to perform one or more of the operations) as described herein.

At 905, the method may include receiving a message that allocates one or more resources for a common power signal associated with a set of UEs including at least the UE. In some examples, aspects of the operations of 905 may be performed by a resource allocation message component 425.

At 910, the method may include transmitting the common power signal via at least one resource of the one or more resources based on the message. In some examples, aspects of the operations of 910 may be performed by a common power signal component 430.

At 915, the method may include receiving control signaling that indicates one of a resource pool for autonomous transmission of uplink data by the set of UEs or a CG procedure for subsequent transmissions of the uplink data by the set of UEs based on the common power signal. In some examples, aspects of the operations of 915 may be performed by a control signaling component 435.

At 920, the method may include receiving, in accordance with the CG procedure, a CG that indicates one or more second resources, where the control signaling indicates the CG procedure based on an estimated quantity of UEs in the set of UEs exceeding a threshold, and where the estimated quantity of UEs is based on the common power signal. In some examples, aspects of the operations of 920 may be performed by a CG component 450.

At 925, the method may include transmitting the uplink data via the one or more second resources indicated via the CG. In some examples, aspects of the operations of 925 may be performed by an uplink data component 445.

The following provides an overview of aspects of the present disclosure:
Aspect 1: A method for wireless communication by a UE, comprising: receiving a message that allocates one or more resources for a common power signal associated with a set of UEs comprising at least the UE; transmitting the common power signal via at least one resource of the one or more resources based at least in part on the message; and receiving control signaling that indicates one of a resource pool for autonomous transmission of uplink data by the set of UEs or a configured grant procedure for subsequent transmissions of the uplink data by the set of UEs based at least in part on the common power signal.
Aspect 2: The method of aspect 1, wherein transmitting the common power signal comprises: transmitting the common power signal using a sequence, wherein the message indicates the sequence associated with the common power signal.
Aspect 3: The method of aspect 2, wherein the sequence is a Zadoff-Chu sequence, a maximum-length sequence, or both.
Aspect 4: The method of any of aspects 1 through 3, wherein transmitting the common power signal comprises: transmitting, in accordance with an OLPC mode of the UE, the common power signal, wherein the control signaling is further based at least in part on enablement of the OLPC mode at each UE of the set of UEs associated with the common power signal.
Aspect 5: The method of any of aspects 1 through 3, wherein the message further comprises mapping information that maps each resource of the one or more resources to a respective range of a plurality of candidate ranges of expected uplink powers, transmission of the common power signal via the at least one resource is based at least in part on an expected uplink power associated with the UE and the mapping information.
Aspect 6: The method of aspect 5, further comprising: determining the expected uplink power associated with the UE based at least in part on a measured downlink reference signal received power and a transmit power associated with the UE; and selecting the at least one resource from among the one or more resources indicated via the message for transmission of the common power signal based at least in part on the mapping information indicating that the at least one resource is mapped to a first range, of the plurality of candidate ranges, that includes the expected uplink power.
Aspect 7: The method of any of aspects 1 through 3, wherein the message further comprises mapping information that maps each resource of the one or more resources to a respective range of a plurality of candidate ranges of uplink payload sizes, transmission of the common power signal via the at least one resource is based at least in part on an uplink payload size associated with the UE and the mapping information.
Aspect 8: The method of aspect 7, further comprising: selecting the at least one resource from among the one or more resources indicated via the message for transmission of the common power signal based at least in part on the mapping information indicating that the at least one resource is mapped to a first range, of the plurality of candidate ranges, that includes the uplink payload size.
Aspect 9: The method of any of aspects 1 through 3, wherein the message further comprises mapping information that maps each resource of the one or more resources to a respective range of a plurality of candidate ranges of MCSs, transmission of the common power signal via the at least one resource is based at least in part on a MCS associated with the UE and the mapping information.
Aspect 10: The method of aspect 9, further comprising: selecting the at least one resource from among the one or more resources indicated via the message for transmission of the common power signal based at least in part on the mapping information indicating that the at least one resource is mapped to a first range, of the plurality of candidate ranges, that includes the MCS.
Aspect 11: The method of any of aspects 1 through 10, further comprising: determining whether the UE has data for transmission via the resource pool, wherein transmitting the common power signal via the at least one resource is based at least in part on determining that the UE does have data for transmission via the resource pool.
Aspect 12: The method of any of aspects 1 through 11, further comprising: autonomously transmitting the uplink data via a second resource randomly selected from the resource pool indicated via the control signaling, wherein the control signaling indicates the resource pool for the autonomous transmission of the uplink data by the set of UEs based at least in part on an estimated quantity of UEs in the set of UEs being less than a threshold, and wherein the estimated quantity of UEs is based at least in part on the common power signal.
Aspect 13: The method of any of aspects 1 through 11, further comprising: receiving, in accordance with the configured grant procedure, a configured grant that indicates one or more second resources, wherein the control signaling indicates the configured grant procedure based at least in part on an estimated quantity of UEs in the set of UEs exceeding a threshold, and wherein the estimated quantity of UEs is based at least in part on the common power signal; and transmitting the uplink data via the one or more second resources indicated via the configured grant.
Aspect 14: A UE for wireless communication, comprising a processing system that includes processor circuitry and memory circuitry that stores code, the processing system configured to cause the UE to perform a method of any of aspects 1 through 13.
Aspect 15: A UE for wireless communication, comprising at least one means for performing a method of any of aspects 1 through 13.
Aspect 16: A non-transitory computer-readable medium storing code for wireless communication, the code comprising instructions executable by one or more processors to perform a method of any of aspects 1 through 13.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive a message that allocates one or more resources for a common power signal associated with a set of UEs comprising at least the UE;
transmit the common power signal via at least one resource of the one or more resources based at least in part on the message; and
receive control signaling that indicates one of a resource pool for autonomous transmission of uplink data by the set of UEs or a configured grant procedure for subsequent transmissions of the uplink data by the set of UEs based at least in part on the common power signal.

2. The UE of claim 1, wherein, to transmit the common power signal, the processing system is configured to cause the UE to:
transmit the common power signal using a sequence, wherein the message indicates the sequence associated with the common power signal.

3. The UE of claim 2, wherein the sequence is a Zadoff-Chu sequence, a maximum-length sequence, or both.

4. The UE of claim 1, wherein, to transmit the common power signal, the processing system is configured to cause the UE to:
transmit, in accordance with an open loop power control mode of the UE, the common power signal, wherein the control signaling is further based at least in part on enablement of the open loop power control mode at each UE of the set of UEs associated with the common power signal.

5. The UE of claim 1, wherein the message further comprises mapping information that maps each resource of the one or more resources to a respective range of a plurality of candidate ranges of expected uplink powers, wherein transmission of the common power signal via the at least one resource is based at least in part on an expected uplink power associated with the UE and the mapping information.

6. The UE of claim 5, wherein the processing system is further configured to cause the UE to:
determine the expected uplink power associated with the UE based at least in part on a measured downlink reference signal received power and a transmit power associated with the UE; and
select the at least one resource from among the one or more resources indicated via the message for transmission of the common power signal based at least in part on the mapping information indicating that the at least one resource is mapped to a first range, of the plurality of candidate ranges, that includes the expected uplink power.

7. The UE of claim 1, wherein the message further comprises mapping information that maps each resource of the one or more resources to a respective range of a plurality of candidate ranges of uplink payload sizes, wherein transmission of the common power signal via the at least one resource is based at least in part on an uplink payload size associated with the UE and the mapping information.

8. The UE of claim 7, wherein the processing system is further configured to cause the UE to:
select the at least one resource from among the one or more resources indicated via the message for transmission of the common power signal based at least in part on the mapping information indicating that the at least one resource is mapped to a first range, of the plurality of candidate ranges, that includes the uplink payload size.

9. The UE of claim 1, wherein the message further comprises mapping information that maps each resource of the one or more resources to a respective range of a plurality of candidate ranges of modulation and coding schemes, wherein transmission of the common power signal via the at least one resource is based at least in part on a modulation and coding scheme associated with the UE and the mapping information.

10. The UE of claim 9, wherein the processing system is further configured to cause the UE to:
select the at least one resource from among the one or more resources indicated via the message for transmission of the common power signal based at least in part on the mapping information indicating that the at least one resource is mapped to a first range, of the plurality of candidate ranges, that includes the modulation and coding scheme.

11. The UE of claim 1, wherein the processing system is further configured to cause the UE to:
determine whether the UE has data for transmission via the resource pool, wherein transmitting the common power signal via the at least one resource is based at least in part on determining that the UE does have data for transmission via the resource pool.

12. The UE of claim 1, wherein the processing system is further configured to cause the UE to:
autonomously transmit the uplink data via a second resource randomly selected from the resource pool indicated via the control signaling, wherein the control signaling indicates the resource pool for the autonomous transmission of the uplink data by the set of UEs based at least in part on an estimated quantity of UEs in the set of UEs being less than a threshold, and wherein the estimated quantity of UEs is based at least in part on the common power signal.

13. The UE of claim 1, wherein the processing system is further configured to cause the UE to:
receive, in accordance with the configured grant procedure, a configured grant that indicates one or more second resources, wherein the control signaling indicates the configured grant procedure based at least in part on an estimated quantity of UEs in the set of UEs exceeding a threshold, and wherein the estimated quantity of UEs is based at least in part on the common power signal; and
transmit the uplink data via the one or more second resources indicated via the configured grant.

14. A method for wireless communication by a user equipment (UE), comprising:
receiving a message that allocates one or more resources for a common power signal associated with a set of UEs comprising at least the UE;
transmitting the common power signal via at least one resource of the one or more resources based at least in part on the message; and
receiving control signaling that indicates one of a resource pool for autonomous transmission of uplink data by the set of UEs or a configured grant procedure for subsequent transmissions of the uplink data by the set of UEs based at least in part on the common power signal.

15. The method of claim 14, wherein transmitting the common power signal comprises:
transmitting the common power signal using a sequence, wherein the message indicates the sequence associated with the common power signal.

16. The method of claim 14, wherein transmitting the common power signal comprises:
transmitting, in accordance with an open loop power control mode of the UE, the common power signal, wherein the control signaling is further based at least in part on enablement of the open loop power control mode at each UE of the set of UEs associated with the common power signal.

17. The method of claim 14, further comprising:
determining whether the UE has data for transmission via the resource pool, wherein transmitting the common power signal via the at least one resource is based at least in part on determining that the UE does have data for transmission via the resource pool.

18. The method of claim 14, further comprising:
autonomously transmitting the uplink data via a second resource randomly selected from the resource pool indicated via the control signaling, wherein the control signaling indicates the resource pool for the autonomous transmission of the uplink data by the set of UEs based at least in part on an estimated quantity of UEs in the set of UEs being less than a threshold, and wherein the estimated quantity of UEs is based at least in part on the common power signal.

19. The method of claim 14, further comprising:
receiving, in accordance with the configured grant procedure, a configured grant that indicates one or more second resources, wherein the control signaling indicates the configured grant procedure based at least in part on an estimated quantity of UEs in the set of UEs exceeding a threshold, and wherein the estimated quantity of UEs is based at least in part on the common power signal; and
transmitting the uplink data via the one or more second resources indicated via the configured grant.

20. A non-transitory computer-readable medium storing code for wireless communication, the code comprising instructions executable by one or more processors to:
receive a message that allocates one or more resources for a common power signal associated with a set of UEs;
transmit the common power signal via at least one resource of the one or more resources based at least in part on the message; and
receive control signaling that indicates one of a resource pool for autonomous transmission of uplink data by the set of UEs or a configured grant procedure for subsequent transmissions of the uplink data by the set of UEs based at least in part on the common power signal.
